(19) United States
(12) Patent Application Publication
(10) Pub. No.: US 2018/0087981 A1
(43) Pub. Date: Mar. 29, 2018

(54) DEVICE FOR MEASURING TORQUE AND DRIVE FOR ACTUATING A MACHINE ELEMENT

(71) Applicant: BÜ-SCH Armaturen Geyer GmbH, Geyer (DE)

(72) Inventors: Joachim LANG, Schönheide (DE); Frank FALTENBACHER, Winkelhaid (DE)

(73) Assignee: BÜ-SCH Armaturen Geyer GmbH, Geyer (DE)

(21) Appl. No.: 15/705,850

(22) Filed: Sep. 15, 2017

(30) Foreign Application Priority Data
Sep. 16, 2016 (EP) 16189114.8

(51) Int. Cl. G01L 3/08; H02K 11/24

(52) U.S. Cl. CPC G01L 3/08; H02K 11/24

(57) ABSTRACT

A device is for the optoelectronic measurement of torque with a first component (2), and a second component (3), it being possible for the first component (2) to be connected to a drive element and the second component (3) to be connected to a drive element, or vice versa. A first encoding element that is arranged on the first component (2). A second encoding element is arranged on the second component (3). A first light barrier (6) detects the rotational movement of the first encoding element. A second light barrier (7) detects the rotational movement of the second encoding element. An electronic evaluation unit (8) detects and evaluates signals originating from the first light barrier (6) and second light barrier (7), with at least one elastic element that is deformable according to a torque acting upon it being provided between the first (2) and the second component (3). When the torque changes, a change in the angle-of-rotation position of the components (2, 3) in relation to one another can be identified and the torque calculated on that basis.

This application claims benefit of Serial No. 16 189 114.8, filed 16 Sep. 2016 in Europe and which application is incorporated herein by reference. To the extent appropriate, a claim of priority is made to above-disclosed application.

The present invention relates to a device for the optoelectronic measurement of torque as well as to a drive for actuating a machine element or an armature, particularly a slide armature.

### TECHNICAL BACKGROUND

A very wide variety of measuring devices for determining a torque acting on a shaft or on a coupling are known. For example, the torque can be measured by means of strain gauges that are fastened to the surface of an axle or shaft. The elongation on the cylinder surface is directly proportional to the torque of the axle or shaft. In order for the rotation or torsion of the shaft to also be measurable, it must have a defined length. The measured values are transmitted via slip rings, for example, which are subjected to a high level of wear.

In addition, optoelectronic methods for measuring torque are known in which the torsion of a component to which a torque is being applied, such as a shaft, is measured by measuring the degree of overlap of two discs mounted next to one another on the shaft. These discs each have recesses or windows distributed uniformly and radially on their periphery. The recesses or windows of the two discs are arranged such that they overlap completely with one another without torque. When the shaft is rotated or twisted, the two discs also move relative to one another. This results in an opening between the recesses or windows of the two discs corresponding to the torsion. The intensity of the light penetrating through the recesses of the discs is measured, with a light source being arranged on one side of the discs and a photometer being arranged on the opposing side of the discs. The light transmission changes proportionally to the torque.

### CLOSEST PRIOR ART

DE 198 49 225 C1 describes a device for the optoelectronic measurement of torque on a machine element using two parallel encoder discs mounted on the machine element, each with raster lines or light windows distributed radially on their periphery. The raster lines are arranged in two concentric zones. A light source is arranged on one side of the encoder discs to which a photometer in the form of photodiodes on the opposite side of the discs is associated. A torsion portion of reduced diameter on which sleeves are shrunk is located on the machine element in the form of a shaft. The encoder discs support the neighboring, free ends of the sleeves. When a torque is applied, the two outer ends of the shaft are rotated toward one another. The sleeves transfer the torsion to the encoder discs seated at their free ends that are rotating toward one another in equal measure. As a result, the throughput cross sections for the transmitted light are changed. The amount of transmitted light, which changes proportionally to the torsion, is recorded by the photodiodes and converted into electrical voltage. During the subsequent electronic processing, the measurement data on the torque are finally ascertained.

EP 3 032 233 A1 discloses a device for the optoelectronic measurement of torque with a first coupling flange that is connected to a first, drive-side shaft, and with a second coupling flange that is connected to a second, output-side shaft, with one of the two shafts being arranged so as to be displaceable in the axial direction. The respective front face of the first and second coupling flanges has at least one inclined plane. In a home position, the inclined planes of the oppositely situated front faces form a torque-transmitting joint. When the torque increases, a change in the angle-of-rotation position of the coupling flanges relative to one another can be detected, and the torque can be determined from this.

### OBJECT OF THE PRESENT INVENTION

The object of the present invention consists in providing a novel device for the optoelectronic measurement of torque that enables torque to be measured with precision without great effort.

### HOW THE OBJECT IS ACHIEVED

According to the invention, at least one elastic element that is deformable according to a torque acting upon it is provided between the first and the second component, and, when the torque changes, a change in the angle-of-rotation position of the components in relation to one another can be identified and the torque calculated on that basis. Since the relative rotation of the first and second components is directly proportion to the torque applied, the measurement can be performed with a high level of accuracy. The rotation of first and second component in relation to one another occurs against the force of the at least one elastic element, which enables a very fast-reacting measurement; that is, the deformation of the elastic element and thus the measurement of the torque reacts immediately when the torque changes. The angle-of-rotation position of the respective component is measured through light barriers. Finally, the torque is determined from the angle-of-rotation offset and/or the resulting time offset in the angle of rotation of the components. It is possible to measure both very small torques and relatively large torques without the need for substantial structural alterations or special components. Only the elastic force or spring force of the elastic element can be selected depending on the torque to be transmitted. Since the elastic element reacts immediately to the change in torque, the arrangement is nearly frictionless. It is thus possible to obtain an immediate and error-free determination of the torque. What is more, by using the light barriers, the device according to the invention also makes it possible to measure torque in a simple and highly precise manner.

The device can be advantageously set up structurally such that the first component has a crosspiece, the crosspiece can be swiveled to the second component over a defined angular range, whereas the second component comprises the elastic element, the crosspiece engages on the elastic element, and a force can be applied to the elastic element upon swiveling of the crosspiece. It is not necessary to interpose additional torque-transmitting elements. This results in a relatively simple but very stable construction. In addition, a temporally precise and immediate determination of the torque is enabled by the immediate action of the crosspiece, which is arranged on the first component, on the elastic element.

In this structural embodiment, the second component can have at least one recess into which the elastic element protrudes and into which the crosspiece engages. The recess thus represents a receptacle for the crosspiece in which the crosspiece can be rotated or swiveled within a defined range and thus applies a load to the elastic element proportionately to the angular range swiveled. The at least one elastic element can be arranged in an additional recess or groove and protrude from there into the recess in which the crosspiece also engages.

It is advantageous for the recess into which the crosspiece to simultaneously form a stop for limiting the angular range of the crosspiece. This ensures that the two components do not experience excessive rotation in relation to one another. At the same time, it is also ensured that no overloading of the elastic elements can occur as a result of the stop. For example, if a machine element or an armature on which the device for measuring torque is arranged has seized up, then it is also possible with the device to release a seized machine element or a seized armature, provided that the torque of the engine is sufficient.

The recess can be arranged on the front side of the second component facing toward the first component, and the crosspiece can be arranged on the front side of the first component facing toward the second component. This enables simple manufacturing and assembly.

Advantageously, the change in torque via the elastic elements can be independent of the direction of rotation, so that the action of the same torque results in the same forces being transmitted in both directions of rotation. The device—and hence the measurement of torque as well—can thus rotate both in the clockwise and counterclockwise directions.

It is especially advantageous for at least one, preferably at least two elastic elements to be provided on both sides of the crosspiece. For instance, a total of particularly four elastic elements can be provided. As needed—for example in adaptation to the torque to be transmitted—any desired number of elastic elements can be provided. The provision of the elastic elements on both sides of the crosspiece enables the torque to be measured independently of the direction of rotation. Depending on the direction in which the crosspiece rotates and thereby applies pressure to the elastic element, the oppositely situated elastic element is relieved proportionately.

Advantageously, the elastic elements can be loaded with pressure by means of the crosspiece in every angle-of-rotation position of the components. This ensures that a spring pressure is also always acting on the relieved spring. The relieved spring thus also remains fixed in a stable position.

It is expedient for the elastic elements to be arranged so as to have point or mirror symmetry in relation to the crosspiece. It is advantageous for the elastic elements to also be arranged so as to have point or mirror symmetry in relation to the perpendicular bisector of the crosspiece. As a result, the torque can be measured independently of the direction of rotation, so that the action of the same torque results in the same forces being transmitted in both directions of rotation. Moreover, the forces act in a symmetrically uniform manner in the coupling region of the two components.

The crosspiece and/or the recess can each widen toward the respective edge region of the first and second components. This enables the simple installation, particularly the simple assembly, of the individual components and elements.

Advantageously, the elastic elements can be oriented toward the change in the angle-of-rotation position in relation to their longitudinal axis. In this way, an optimal compressive loading of the elastic elements is achieved in the direction of rotation of the components.

It is expedient for a spring, particularly a coil spring, preferably a helical compression spring, to be provided as an elastic element. A corresponding coil spring or helical compression spring has the advantage that it is economical, withstands the acting pressure over a relatively wide range, depending on the spring constant, can be easily inserted into the recess provided for it, and is characterized by a high fatigue limit and stability.

The first and second components can be embodied in this device such that they cannot be displaced relative to one another in the axial direction when in the coupled state. Therefore, no axial movement of the components in relation to one another is necessary. This results in the advantage that the coupling can be of a very general nature without the need for special components.

The crosspiece can be swivelable relative to the second component over an angular range of +/−30°, preferably over an angular range of +/−20°, especially over an angular range of +/−10°. A commensurately large torque can thus be measured.

Advantageously, the first and/or second encoding element can be embodied as an encoder disc or encoder discs. Such commercially available encoder discs can be attached in a simple manner to the first and second component.

In order to enable the rotational movement of the encoder discs and the rotation of the encoder discs in relation to one another or the rotational movement and rotation of other encoding elements in relation to one another by means of the light barriers, the encoder discs or encoding elements can have recesses arranged in regular fashion around their periphery. The light of the light barriers can pass through the recesses, thereby enabling the rotational movement to be determined. Finally, the torque can be determined from the time offset of the light barrier signals.

The device can have a housing that encloses the first and second components. Light barriers that are correctly aligned relative to the encoder discs can also be attached to this housing.

The inventive drive for actuating a machine element or an armature, particularly a slide armature, has a motor that comprises a stator, a rotor, and a motor shaft, with the motor shaft being equipped with a device for the optoelectronic measurement of torque—as was just described. A corresponding slide armature can absorb torques in a range of approximately 150 nM, which the device for measuring torque can also measure.

In a corresponding drive for actuating a machine element or an armature, the motor shaft and/or the rotor are not displaceable in the axial direction. It is at least not necessary for the motor shaft and/or the rotor to be displaceable in the axial direction. The torque is measured exclusively by way of the rotational movement of the first and second components relative to one another.

The motor can have a housing, in which case the device for the optoelectronic measurement of torque is located outside of this housing, however. The device for measuring torque is thus easily accessible, and there is sufficient space available for mounting the encoder discs as well as the light barriers.

### DESCRIPTION OF THE INVENTION ON THE BASIS OF EXEMPLARY EMBODIMENTS

The invention will be explained in further detail with reference to advantageous exemplary embodiments according to the figures of the drawing.

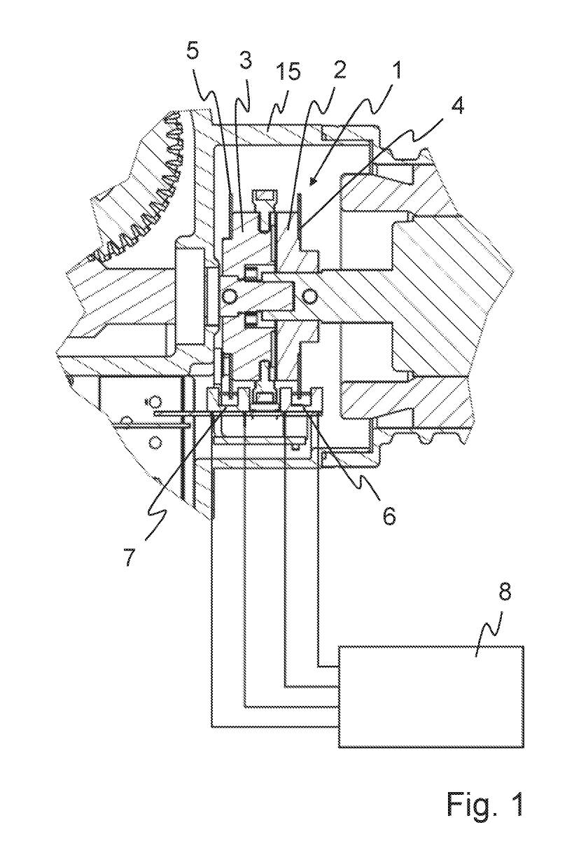

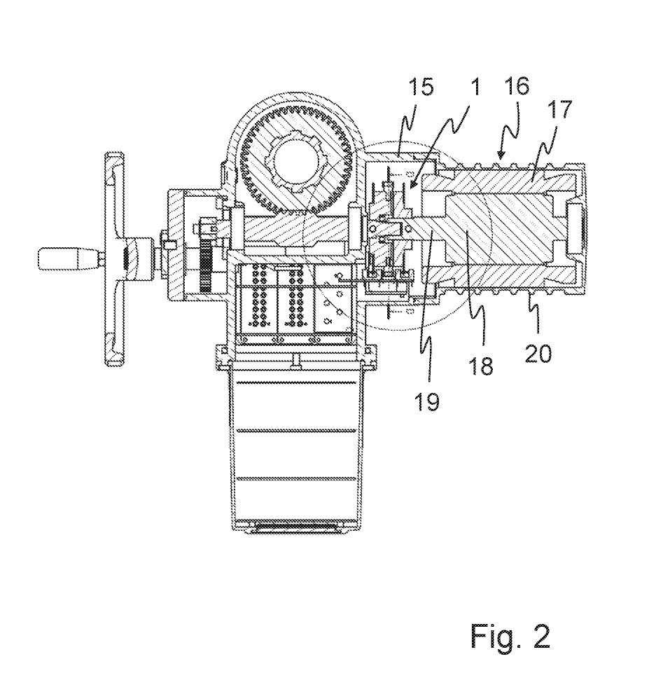

FIG. 1 shows a schematic, partially sectional representation of a device for the optoelectronic measuring torque with an electronic evaluation unit (cut-out from FIG. 2);

FIG. 2 shows a schematic, partially sectional representation of a drive for actuating a machine element; and

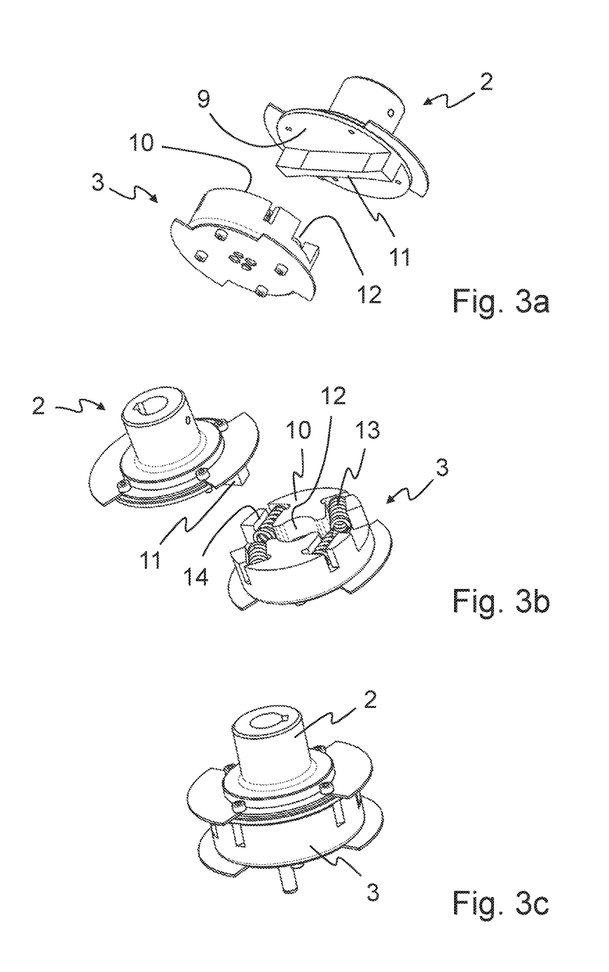

FIG. 3 shows three perspective representations (FIGS. 3a-3c) in the area of the first and second components, with the components in FIGS. 3a and 3b not being coupled and being coupled in FIG. 3c.

Reference number 1 designates the device according to the invention for the optoelectronic measurement of torque in its entirety. As can be seen from FIG. 1, the device comprises a first component 2 and a second component 3. The first component 2 is connected to a drive element, and the second component 3 is connected to a drive element. Furthermore, a first encoder disc 4 is provided which is arranged in a rotationally fixed manner on the first component 2. A second encoder disc 5 is arranged in a rotationally fixed manner on the second component 3. A first light barrier 6 detects the rotational movement of the first encoder disc 4, and a second light barrier 7 detects the rotational movement of the second encoder disc 5. An electronic evaluation unit 8 is used to detect and evaluate the signals originating from the first light barrier 6 and from the second light barrier 7.

Moreover, it is used to store defined torque characteristics. These make it possible to compare current measurements with previous measurements.

Moreover, four springs 13 are that are deformable according to a torque acting upon them are provided between the first component 2 and the second component 3, and, when the torque changes, a change in the angle-of-rotation position of the components 2, 3 in relation to one another can be identified and the torque calculated on that basis. The first and second components 2, 3 cannot be displaced relative to one another in the axial direction in the coupled state.

The first and second components 2, 3 are shown in detail in FIGS. 3a-c. The first component 2 has a crosspiece 11 that can be swiveled to the second component 3 over a defined angular range. The crosspiece 11 acts on the springs 13 when the components 2, 3 rotate. As a whole, the two components 2, 3, together with their crosspiece 11 and the springs 13, form a torque-transmitting assemblage. FIGS. 3a and 3b show the two components 2, 3 in the non-coupled state, so that the individual designs and elements are visible. FIG. 3c shows the two components 2, 3 in the coupled state.

When the torque increases—for example, when a torsional force acts on the drive element connected to the first component 2—the crosspiece 11 transfers the force in a direction to the springs 13, which deform according to the acting force. This means that two springs 13 are compressed, whereas the other two springs 13 expand. The resulting angle-of-rotation position of the components relative to one another can be detected by means of the encoder discs 4, 5 and the light barriers 6, 7 arranged thereon. The time offset of the signals of the light barriers 6, 7 enables a conversion to the acting torque. By virtue of the springs 13 and the direct transfer of the force through the crosspiece 11, the arrangement is nearly frictionless and responds extremely quickly.

The second component 3 has a recess 12 into which the springs 13 protrude and in which the crosspiece 11 engages in the coupled state of the two components.

The crosspiece 11 can then be swiveled within the recess 12 over the defined angular range and applies more or less force to the springs 13 depending on the torque. The recess 12 simultaneously forms a stop that defines the swivelable angular range of the crosspiece 11.

The recess 12 is arranged on the front side 10 of the second component 3 facing toward the first component 2. The crosspiece 11 is arranged on the front side 9 of the first component 2 facing toward the second component 3. The springs 13 are located in recesses 14, which lead to the recess 12. The springs 13 arranged in the recesses protrude into the recess 12, so that a load can be applied to them with the crosspiece 11.

The springs 13 are arranged in mirror symmetry on the two sides of the crosspiece 11. The change in torque is thus independent of the direction of rotation and suitable both for clockwise and counterclockwise rotation.

The springs 13 are loaded by means of the crosspiece 11 with pressure in every angle-of-rotation position of the components 2, 3. As a result, a spring pressure is always being applied even to the comparatively relieved spring 13.

The crosspiece 11 and the recess 12 each widen toward the respective edge region of the first and second components 2, 3. This configuration has the advantage that assembly is made easier as a result.

With respect to their longitudinal axes, the springs 13 are oriented or positioned in the direction of the change in the angle-of-rotation position and thus absorb the force acting via the crosspiece 11 directly for their deformation in the longitudinal direction.

The crosspiece 11 can be swivelable relative to the second component 3 over an angular range of +/−30°, preferably over an angular range of +/−20°, especially over an angular range of +/−10°. A corresponding torque range is thus measured.

Should it be necessary in a given case to measure a higher torque, then the number of springs can be increased as desired and/or springs with a higher spring constant can be used.

As can also be seen from FIGS. 3a-c, the encoder discs 4, 5 each have directly opposing recesses 14 through which the light of the light barriers 6, 7 passes. In the electronic evaluation unit 8, a determination of or conversion to the torque is performed on the basis of the time offset of the detected light barrier signals of the encoder discs 4 and 5.

The device 1 also has a housing 15 that encloses the first and second components 2, 3. Accordingly, the encoder discs 4, 5 can be expediently arranged within the housing 15 as well and thus be protected from external influences.

FIG. 2 shows a drive for actuating a machine element or armature, particularly a slide armature. This drive can have a motor 16, which can comprise a stator 17, a rotor 18, and a motor shaft 19. The motor shaft 19 is equipped at its front end with the above-described device 1 for the optoelectronic measurement of torque. In the depicted exemplary embodiment, both the motor shaft 19 and the rotor 18 cannot be displaced in the axial direction, which is also not necessary for measuring the torque.

With the illustrated drive, for example, slide armatures (not shown)—e.g., slide armatures without a housing—can be actuated in order to block water flows at pipes or channel lines. Using the device for measuring torque, a maximum torque can be set, for example in order to prevent a slide armature from being damaged in the case of an obstruction. For instance, an alarm can be triggered when the set torque is exceeded.

### LIST OF REFERENCE SYMBOLS

1 device
2 first component
3 second component
4 first encoder disc
5 second encoder disc
6 first light barrier
7 second light barrier
8 electronic evaluation unit
9 front side
10 front side
11 crosspiece
12 recess
13 spring
14 recess
15 housing
16 motor
17 stator
18 rotor
19 motor shaft
20 housing

1. A device for optoelectronic measurement of torque, the device comprising:
a first component,
a second component,
wherein the first component can be connected to a drive element and the second component can be connected to a drive element, or vice versa,
a first encoding element arranged on the first component,
a second encoding element arranged on the second component,
a first light barrier detecting rotational movement of the first encoding element,
a second light barrier detecting rotational movement of the second encoding element,
an electronic evaluation unit for detecting and evaluating the signals originating from the first light barrier and from the second light barrier,
at least one elastic element, the elastic element being deformable according to a torque acting upon the elastic element, the elastic element being between the first component and the second component, and, when the torque changes, a change in an angle-of-rotation position of the componenr in relation to one another is identifiable and the torque calculated on a basis of the change in the angle-of-rotation position of the components in relation to one another.

2. The device as set forth in claim 1, wherein
the first component has a crosspiece swivelable to the second component over a defined angular range,
the second component comprises the elastic element, the crosspiece engages the elastic element, and a force can be applied to the elastic element upon swiveling of the crosspiece.

3. The device as set forth in claim 2, wherein the second component has at least one recess into which the elastic element protrudes and in which the crosspiece engages.

4. The device as set forth in claim 2, wherein the recess forms a stop for limiting the angular range of the crosspiece.

5. The device as set forth in claim 2, wherein the recess is arranged on a front side of the second component facing toward the first component, and the crosspiece is arranged on the front side of the first component facing toward the second component.

6. The device as set forth in claim 1, wherein the change in the torque via the elastic elements is independent of direction of rotation.

7. The device as set forth in claim 1, wherein at least two elastic elements are provided on both sides of the crosspiece.

8. The device as set forth in claim 1, wherein the elastic elements are loaded with pressure by the crosspiece in every angle-of-rotation position of the components.

9. The device as set forth in claim 2, wherein the elastic elements are arranged so as to have point or mirror symmetry in relation to the crosspiece.

10. The device as set forth in claim 1, wherein the crosspiece and/or the recess each widens toward a respective edge region of the first and second components.

11. The device as set forth in claim 1, wherein the elastic element or the elastic elements are oriented toward the change in the angle-of-rotation position in relation to longitudinal axis of the elastic element or the elastic elements.

12. The device as set forth in claim 1, wherein a spring is provided as an elastic element.

13. The device as set forth in claim 1, wherein the first and second components are prevented from being displaced in the axial direction toward one another in the coupled state.

14. The device as set forth in claim 1, wherein the crosspiece can be swiveled relative to the second component over an angular range of +/−30°.

15. The device as set forth in claim 1, wherein the first and/or second encoding element is embodied as an encoder disc or encoder discs.

16. The device as set forth in claim 1, wherein the encoding elements have recesses arranged in regular fashion around a periphery of the encoding elements.

17. The device as set forth in claim 1, wherein the device has a housing enclosing the first and second components.

18. A drive for actuating a machine element or a slide armature, the drive comprising:
a motor comprising a stator, a rotor, and a motor shaft, wherein
the motor shaft is equipped with a device for the optoelectronic measurement of torque as set forth in claim 1.

19. The drive as set forth in claim 18, wherein
the motor shaft and/or the rotor cannot be are prevented from being displaced in the axial direction.

20. The drive as set forth in claim 18, wherein the motor has a housing and the device for the optoelectronic measurement of torque is located outside of the housing.
